(19) United States
(12) Patent Application Publication
(10) Pub. No.: US 2021/0291893 A1
(43) Pub. Date: Sep. 23, 2021

(54) POWER STEERING APPARATUS

(71) Applicant: MAZDA MOTOR CORPORATION, Hiroshima (JP)

(72) Inventors: Tetsuya NOZAWA, Aki-gun (JP); Kenta TADA, Aki-gun (JP)

(73) Assignee: MAZDA MOTOR CORPORATION, Hiroshima (JP)

(21) Appl. No.: 17/179,171

(22) Filed: Feb. 18, 2021

(30) Foreign Application Priority Data
Mar. 18, 2020 (JP) 2020-048105

(51) Int. Cl. B62D 5/00; B62D 5/04; B62D 6/00

(52) U.S. Cl. CPC B62D 5/006; B62D 6/00; B62D 5/0463

(57) ABSTRACT

Vibration is appropriately produced for a steering wheel in a power steering apparatus in which restriction is placed on a torque generated by a motor. In response to establishment of a predetermined condition, an electrical control unit (ECU) which controls actuation of a motor sets a vibration torque for vibrating a steering wheel, sets a summed value of an assist torque and the vibration torque as a target torque, and controls the motor such that the target torque is generated. In addition, when the predetermined condition is not satisfied and the target torque is the predetermined first restriction torque or greater, the ECU restricts a maximum value of the target torque to a first restriction torque, and when the predetermined condition is satisfied, the ECU changes the restriction on the maximum value of the target torque.

### BACKGROUND

### Technical Field

The technique disclosed herein belongs to a technical field related to a power steering apparatus.

### Background Art

A power steering apparatus has been conventionally known which has a motor assisting a steering operation by a driver of a vehicle.

For example, Japanese Patent Laid-Open No. 2019-101086 discloses a power steering apparatus that controls driving of a motor such that a steering wheel vibrates in the opposite direction to a deviation direction in a case where a deviation amount of a vehicle with respect to a specified direction is larger than a reference deviation amount defined in advance.

Further, Japanese Patent Laid-Open No. 2019-101086 discloses that a temporary target current to be supplied to the motor is set based on a steering torque of the steering wheel, an additional current to be supplied to the motor for vibrating the steering wheel is set, and the current value resulting from addition of the temporary target current and the additional current is set as a final target current.

### SUMMARY

In a power steering apparatus disclosed in Japanese Patent Laid-Open No. 2019-101086, because a steering wheel vibrates when a vehicle is about to deviate from a traveling lane, a driver is easily alerted to maintain the traveling lane.

Incidentally, in a power steering apparatus, in a case where a torque generated by a motor is excessively large, this may become a cause of trouble with the motor. In order to inhibit this, a restriction value is provided for the torque generated by the motor, and the motor is thereby controlled such that a larger torque than the restriction value is not generated.

In a case where a vibration torque is simply added to an assist torque assisting steering by the driver as the power steering apparatus disclosed in Japanese Patent Laid-Open No. 2019-101086, when the assist torque exceeds the restriction value, the vibration torque is not generated, and vibration of the steering wheel does not occur. In particular, in steering in an emergency, the possibility is high that the vehicle deviates from the traveling lane, and necessity of vibrating the steering wheel is thus high. However, because the torque generated by the motor becomes large and is likely to reach the restriction value, an event occurs that vibration of the steering wheel is not produced.

The technique disclosed herein appropriately produces vibration for a steering wheel in a power steering apparatus in which restriction is placed on a torque generated by a motor.

Accordingly, the technique disclosed herein is directed to a power steering apparatus. The power steering apparatus includes a motor giving an assist torque to a steering apparatus including a steering wheel operated by a driver. The power steering apparatus further includes a controller controlling actuation of the motor, and in response to establishment of a predetermined condition, the controller sets a vibration torque for vibrating the steering wheel, sets a summed value of the assist torque and the vibration torque as a target torque, and controls the motor such that the target torque is generated. When the predetermined condition is not satisfied and the target torque is a predetermined first restriction torque or greater, the controller further restricts a maximum value of the target torque to the first restriction torque, and when the predetermined condition is satisfied, the controller further changes the restriction on the maximum value of the target torque.

In this configuration, although the first restriction torque is provided, when it is necessary to vibrate the steering wheel, the restriction on the target torque is changed. Accordingly, for example, when the vibration torque is produced, a restriction value of the target torque (in other words, the possible maximum value of the target torque) is temporarily set to a value larger than the first restriction torque, the target torque is thereby caused not to be restricted to the first restriction torque, and vibration of the steering wheel can thereby be produced. Consequently, vibration can appropriately be produced for the steering wheel.

In one embodiment of the power steering apparatus, when the predetermined condition is satisfied, the controller periodically changes a restriction value of the target torque to the first restriction torque and a second restriction torque different from the first restriction torque.

That is, when the maximum value of the target torque is periodically (at a specific frequency) changed to the first restriction torque and the second restriction torque, a torque produced by the motor increases and decreases, and pseudo vibration can thus be produced for the steering wheel. Thus, vibration of the steering wheel can more appropriately be produced.

In the above embodiment, a configuration may be made such that the second restriction torque is smaller than the first restriction torque.

In this configuration, the target torque is alternately changed to the first restriction torque and the second restriction torque in a specific period. Accordingly, because the torque produced by the motor increases and decreases, pseudo vibration can be produced for the steering wheel. Thus, vibration of the steering wheel can more appropriately be produced.

Further, because as a result the target torque does not exceed the first restriction torque, trouble with the motor can efficiently be inhibited as well.

As described above, the technique disclosed herein can appropriately produce vibration for a steering wheel in a power steering apparatus in which restriction is placed on a torque generated by a motor.

### BRIEF DESCRIPTION OF THE DRAWINGS

FIG. 1 is an outline diagram illustrating a power steering apparatus according to a first exemplary embodiment;

FIG. 2 is a block diagram illustrating a configuration of a steering electrical control unit (ECU);

FIG. 3 is an outline diagram illustrating one example of a situation in which forced vibration is produced;

FIG. 4 is a schematic diagram illustrating a producing method of the forced vibration;

FIG. 5 is a graph representing a target torque and illustrates a case of a power steering apparatus in related art;

FIG. 6 is a graph representing the target torque and illustrates a case of the power steering apparatus according to the first embodiment;

FIG. 7 is a flowchart illustrating a processing action of the steering ECU;

FIG. 8 is a graph representing the target torque and illustrates a case of a power steering apparatus according to a second embodiment;

FIG. 9 is a flowchart illustrating a processing action of a steering ECU in a case of producing the forced vibration in the power steering apparatus according to the second embodiment; and

FIG. 10 is an outline diagram illustrating another example of the situation in which forced vibration is produced.

### DETAILED DESCRIPTION

Exemplary embodiments will hereinafter be described in detail with reference to drawings.

### First Embodiment

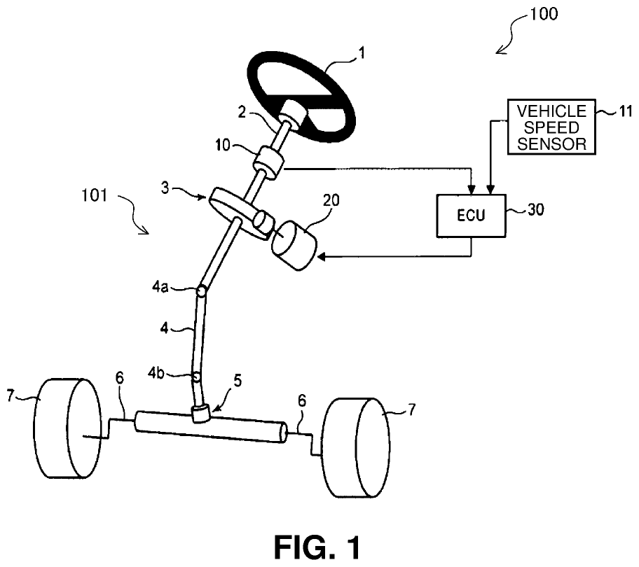

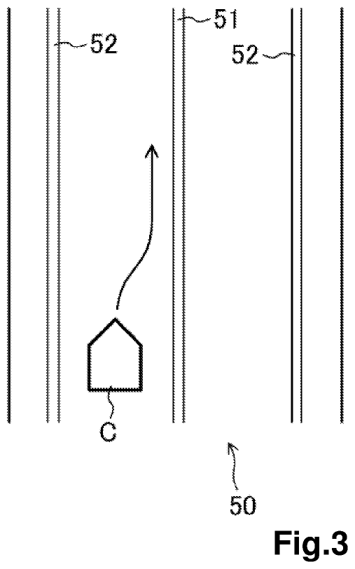

As illustrated in FIG. 1, a power steering apparatus 100 according to a first embodiment is a steering apparatus installed in a vehicle C (see FIG. 3) such as a four-wheel automobile. The power steering apparatus 100 includes a steering apparatus 101. The steering apparatus 101 has a steering wheel 1, a steering shaft 2, an intermediate shaft 4 having universal joints 4a and 4b, a pinion-rack mechanism 5, and a tie rod 6 coupled with front wheels 7. The power steering apparatus 100 includes an assist motor 20 (hereinafter simply referred to as motor 20) for giving an assist torque to the steering apparatus 101. The motor 20 is joined to the steering shaft 2 via a reduction gear 3. A steering torque sensor 10 is provided to a steering shaft 2. The steering torque sensor 10 detects a torque in a case where a user operating the power steering apparatus 100 (mainly a driver of the vehicle C) performs steering.

The motor 20 is controlled by a steering ECU 30 (electrical control unit, hereinafter simply referred to as ECU 30). The ECU 30 is computer hardware configured with a processor, a memory having plural modules, and so forth. The ECU 30 corresponds to a controller.

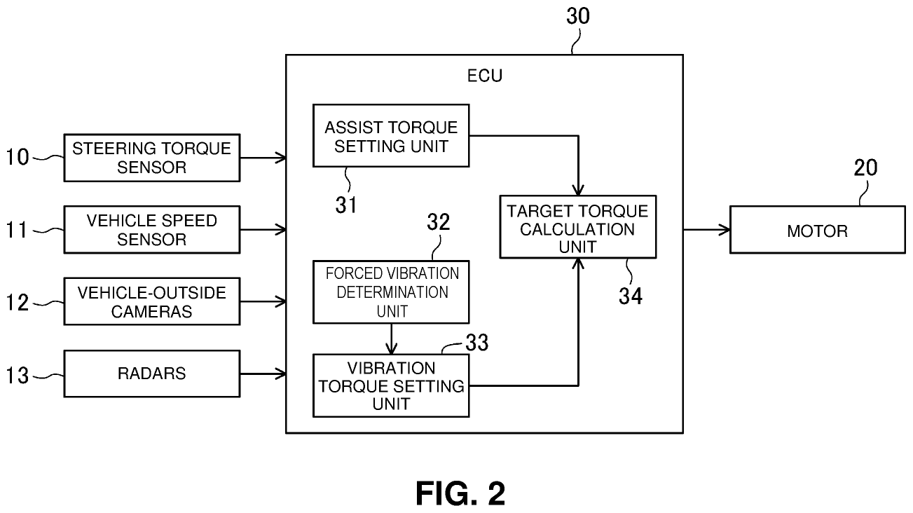

As illustrated in FIG. 2, the ECU 30 generates a control signal for the motor 20 based on information input from plural sensors. The plural sensors include the steering torque sensor 10 detecting a steering torque by the driver, a vehicle speed sensor 11 detecting a vehicle speed of the vehicle C, plural cameras 12 provided to a body or the like of the vehicle and photographing an environment on the outside of the vehicle, and plural radars 13 provided to the body or the like of the vehicle C and detecting an object and so forth on the outside of the vehicle.

The cameras 12 are disposed so as to be capable of performing photographing through 360° in the horizontal direction around the vehicle C. The ECU 30 recognizes a white line on a road on which the vehicle C travels and an obstacle present around the vehicle C from images photographed by the cameras 12.

Similar to the cameras 12, the radars 13 are disposed so as to expand a detection range to 360° in the horizontal direction around the vehicle C. The ECU 30 recognizes a relative position or a relative speed with respect to the white line or the obstacle from detection results of the radars 13. A kind of the radar 13 is not particularly limited, and a millimeter-wave radar or an infrared radar may be employed, for example.

Note that the radar 13 does not necessarily have to be provided, but the ECU 30 may calculate a relative position or the like with respect to the white line or the obstacle from photographed images by the cameras 12.

The ECU 30 has an assist torque setting unit 31 setting an assist torque to be output by the motor 20. The assist torque setting unit 31 sets the assist torque based on the steering torque detected by the steering torque sensor 10 and the vehicle speed detected by the vehicle speed sensor 11. Although not illustrated, the assist torque setting unit 31 has a map for setting the assist torque, applies the detected steering torque and the detected vehicle speed to the map, and thereby obtains the assist torque to be set. The map is a map in which a larger torque is set as the steering torque is larger or as the vehicle speed is lower. The assist torque setting unit 31 is a portion of the modules installed in the memory.

In this first embodiment, the ECU 30 forcibly vibrates the steering wheel 1 in response to establishment of a predetermined condition. Specifically, the ECU 30 forcibly vibrates the steering wheel 1 when the vehicle C might deviate from a traveling lane. The ECU 30 has a forced vibration determination unit 32 determining whether or not it is necessary to forcibly vibrate the steering wheel 1, that is, whether or not the vehicle C might deviate from the traveling lane. The forced vibration determination unit 32 is a portion of the modules installed in the memory.

The forced vibration determination unit 32 determines whether or not the vehicle C might deviate from the traveling lane from detection results of the cameras 12 and the radars 13. FIG. 3 illustrates one example of a situation in which forced vibration is produced. A road 50 illustrated in FIG. 3 is a road which has one lane on each side, and a solid center line 51 is drawn at the center of a roadway. On both sides of the roadway in the width direction, roadway outer-side lines 52 are drawn which divide the roadway from roadside strips. Those road conditions are acquired by the cameras 12 and the radars 13. It is assumed that the vehicle C approaches the center line 51 as illustrated in FIG. 3. In this case, the forced vibration determination unit 32 calculates the distance between the vehicle C and the center line 51 from the detection results of the cameras 12 and the radars 13. Then, in a case where this distance is less than a predetermined distance, the forced vibration determination unit 32 determines that the vehicle C might deviate from the traveling lane and determines that the forced vibration of the steering wheel 1 has to be executed. The predetermined distance is 50 cm, for example. Note that FIG. 3 illustrates a case where the vehicle C approaches the center line 51; however, the forced vibration determination unit 32 also determines that the vehicle C might deviate from the traveling lane in a case where the vehicle C approaches the roadway outer-side line 52. Note that the forced vibration determination unit 32 determines that the predetermined condition is not satisfied when a winker switch (not illustrated) is in an ON state and the vehicle C deviates from the white line for changing lanes.

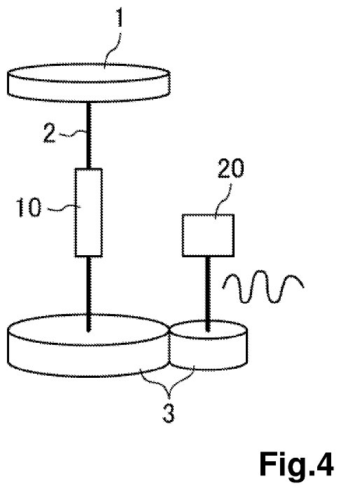

The ECU 30 has a vibration torque setting unit 33 that sets a vibration torque for producing the forced vibration when the forced vibration determination unit 32 determines that the forced vibration of the steering wheel 1 has to be executed. In this first embodiment, the forced vibration is produced for the steering wheel 1 by using the motor 20. That is, as illustrated in FIG. 4, the vibration torque setting unit 33 sets a torque like a pulse wave with a specific period (hereinafter referred to as vibration torque) and causes the motor 20 to generate the vibration torque. This vibration torque is transmitted to the steering wheel 1 via the reduction gear 3 and the steering shaft 2. Accordingly, the steering wheel 1 quickly and repetitively moves in the circumferential direction, and this movement is transmitted as vibration to the driver. In a case of the forced vibration for attracting attention to deviation from the traveling lane, the vibration torque is set to a torque in the opposite direction to the steering torque (that is, the assist torque). Further, an amplitude of the vibration torque is set to such an amplitude that the vehicle C does not turn, that is, to such an amplitude that steered wheels (the front wheels 7 herein) do not rotate. Accordingly, an increase in the assist torque by the vibration torque is inhibited, and the possibility can be lowered that the vehicle C deviates from the traveling lane. The vibration torque setting unit 33 is a portion of the modules installed in the memory.

The ECU 30 has a target torque setting unit 34 calculating the summed value of the assist torque set by the assist torque setting unit 31 and the vibration torque set by the vibration torque setting unit 33 and calculating a final target torque. The target torque setting unit 34 calculates the target torque and sets a target current to be supplied to the motor 20 for achieving the target torque. Further, the target torque setting unit 34 outputs a control signal to the motor 20 so as to actuate the motor 20 by the target current. The target torque setting unit 34 is a portion of the modules installed in the memory.

Here, because an excessive load is applied to the motor 20 in a case where a torque generated by the motor 20 is excessively large, the motor 20 might have trouble. Thus, for example, it is possible that a predetermined first restriction torque Tr1 is set at which the possibility of trouble with the motor 20 is low and when the target torque is the first restriction torque Tr1 or greater, the target torque is restricted to the first restriction torque Tr1. Accordingly, the torque generated by the motor 20 is inhibited from becoming excessively large.

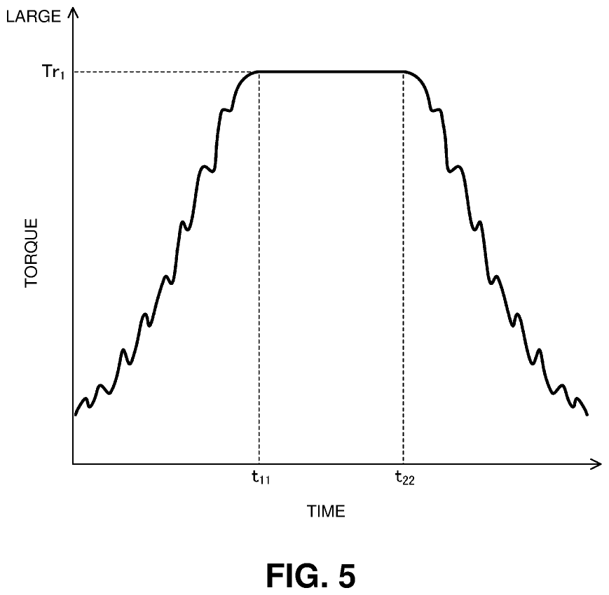

However, in a case where a restriction value of the target torque (in other words, the possible maximum value of the target torque) is fixed to the first restriction torque Tr1, the forced vibration might not be capable of being produced when the forced vibration of the steering wheel 1 is necessary. This will be described with reference to FIG. 5.

FIG. 5 illustrates a change in the target torque. FIG. 5 illustrates the change in the target torque in a case where a predetermined condition is satisfied in a turn to the left. As illustrated in FIG. 5, when the predetermined condition is satisfied, the vibration torque is added to the assist torque. Then, it is assumed that the target torque reaches the first restriction torque Tr1 at time t11. If the restriction value of the target torque is fixed to the first restriction torque Tr1, as illustrated in FIG. 5, the vibration torque is not reflected in a range in which the target torque becomes the first restriction torque Tr1 or greater (the range of time T11 to time t12). Thus, in the range in which the target torque becomes the first restriction torque Tr1 or greater, the steering wheel 1 does not vibrate, and deviation from the traveling lane may not be notified to the driver.

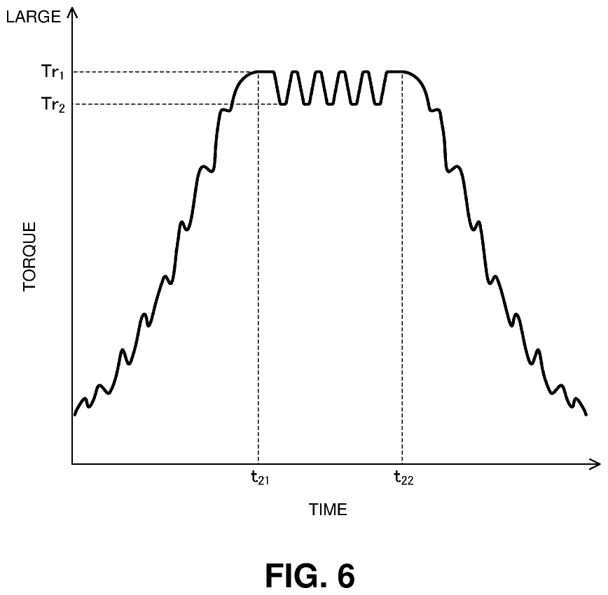

Accordingly, in this first embodiment, when the predetermined condition is not satisfied and the target torque is the predetermined first restriction torque Tr1 or greater, the target torque setting unit 34 restricts the maximum value of the target torque to the first restriction torque Tr1, and when the predetermined condition is satisfied, the target torque setting unit 34 changes the restriction on the target torque. Specifically, the target torque setting unit 34 periodically changes the possible maximum value of the target torque from the first restriction torque Tr1 to a second restriction torque Tr2 smaller than the first restriction torque Tr1. That is, as illustrated in FIG. 6, when the target torque becomes the first restriction torque Tr1 or greater at time t21, the restriction value of the target torque is changed to the second restriction torque Tr2 in a specific period. Specifically, the restriction value of the target torque is alternately changed to the first restriction torque Tr1 and the second restriction torque Tr2 in a period of the specific period. Accordingly, even in the range in which the target torque becomes the first restriction torque Tr1 or greater (between time t21 and time t22 in FIG. 6), increases and decreases occur to the target torque, and pseudo vibration can thus be produced for the steering wheel 1. When the target torque becomes less than the first restriction torque Tr1 at time t22, the summed value of the assist torque and the vibration torque is set as the target torque. This period in which the restriction value of the target torque is set to the second restriction torque Tr2 is preferably set such that a frequency of vibration produced by setting the restriction value to the second restriction torque Tr2 becomes a frequency of the vibration torque. Further, the value of the second restriction torque Tr2 is preferably set approximately to the value resulting from subtraction of the value corresponding to the amplitude of the vibration torque from the first restriction torque Tr1.

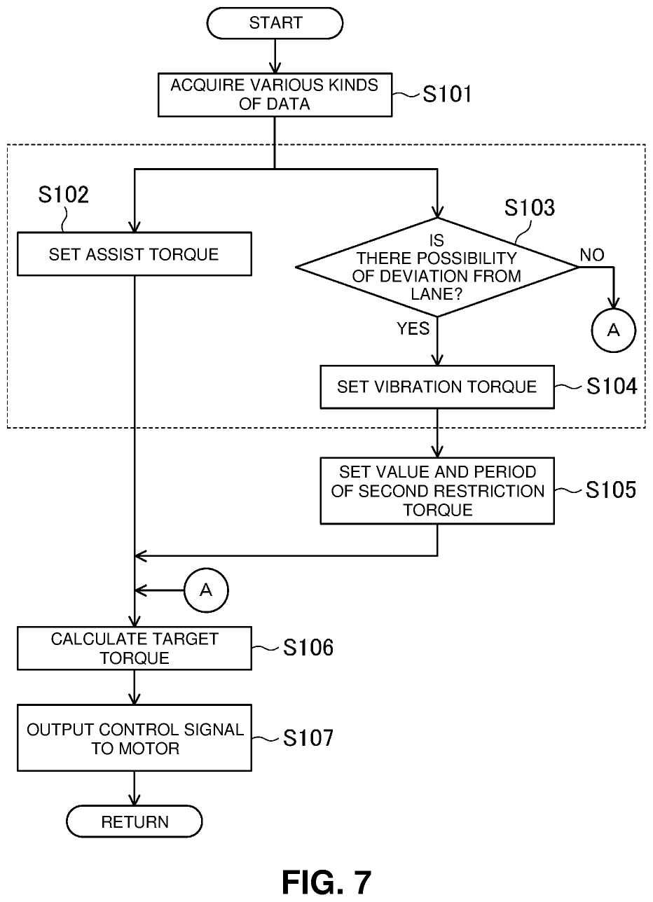

Next, a description will be made about a processing action of the ECU 30 according to this first embodiment with reference to FIG. 7.

In step S101, the ECU 30 acquires various kinds of data from the sensors 10 to 13.

Next, the ECU 30 in parallel processes step S102, step S103, and step S104.

In the step S102, the ECU 30 sets the assist torque. The ECU 30 sets the assist torque based on the steering torque detected by the steering torque sensor 10 and the vehicle speed detected by the vehicle speed sensor 11.

Meanwhile, in the step S103, the ECU 30 determines whether or not there is a possibility of deviation from the lane. The ECU 30 makes a determination based on detection values of the cameras 12 and the radars 13. The ECU 30 moves to step S104 in a case of YES where there is the possibility of deviation from the lane but moves to step S106 in a case of NO where there is no possibility of deviation from the lane.

In the step S104, the ECU 30 sets the vibration torque. The ECU 30 sets the vibration torque such that the torque in the opposite direction to the steering torque is produced.

In the step S105, the ECU 30 sets the value of the second restriction torque Tr2 and the period in which the restriction value of the target torque is set to the second restriction torque Tr2.

In next step S106, the ECU 30 sums the assist torque and the vibration torque, compares the summed value with the first restriction torque, and calculates the final target torque.

Then, in step S107, the ECU 30 outputs the control signal to the motor 20 such that the target torque calculated in the step S106 is generated.

Note that in the flowchart of FIG. 7, as long as the predetermined condition is established, even when the target torque does not become the first restriction torque or greater, the restriction on the target torque is executed. However, the restriction on the target torque may be executed only when the predetermined condition is established and the target torque becomes the first restriction torque or greater.

Consequently, in this first embodiment, the ECU 30 is provided which controls actuation of the motor 20, and in response to establishment of the predetermined condition, the ECU 30 sets the vibration torque for vibrating the steering wheel 1, sets the summed value of the assist torque and the vibration torque as the target torque, and controls the motor 20 such that the target torque is generated. In addition, when the predetermined condition is not satisfied and the target torque is the predetermined first restriction torque Tr1 or greater, the ECU 30 restricts the maximum value of the target torque to the first restriction torque Tr1, and when the predetermined condition is satisfied, the ECU 30 changes the restriction on the target torque. As described above, although the first restriction torque Tr1 is provided, when it is necessary to vibrate the steering wheel 1, the restriction on the target torque is changed. Accordingly, by not restricting the target torque to the first restriction torque Tr1, vibration of the steering wheel 1 can be produced.

In particular, in this first embodiment, when the predetermined condition is satisfied, the ECU 30 periodically changes the restriction value of the target torque to the first restriction torque Tr1 and the second restriction torque Tr2 smaller than the first restriction torque Tr1. Accordingly, the restriction value of the target torque is alternately changed to the first restriction torque Tr1 and the second restriction torque Tr2 in the specific period. Even in the range in which the target torque becomes the first restriction torque Tr1 or greater, increases and decreases occur to the target torque, and pseudo vibration can thus be produced for the steering wheel 1. Further, because the target torque does not exceed the first restriction torque Tr1, trouble with the motor 20 can efficiently be inhibited as well.

### Second Embodiment

A second embodiment will hereinafter be described in detail with reference to the drawings. Note that in the following description, the same reference characters will be given to the portions common to the above first embodiment, and detailed descriptions thereof will not be made.

In this second embodiment, a configuration of the steering apparatus 101 of the power steering apparatus 100 is the same as the above first embodiment. This second embodiment is different from the above first embodiment in control by the ECU 30 in a case where the predetermined condition is satisfied. Specifically, in this second embodiment, when the predetermined condition, that is, the condition that the vehicle C might deviate from the traveling lane is satisfied, the target torque setting unit 34 of the ECU 30 changes the restriction value of the target torque to a third restriction torque Tr3 larger than the first restriction torque Tr1.

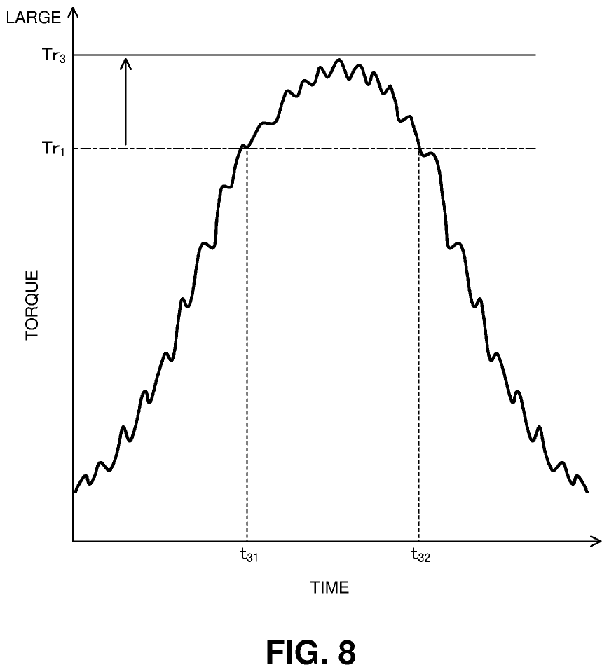

FIG. 8 illustrates a change in the target torque in a case where the predetermined condition is satisfied and the restriction value of the target torque is changed to the third restriction torque Tr3. As illustrated in FIG. 8, it is assumed that the target torque reaches the first restriction torque Tr1 at time t31. Because the restriction value of the target torque is changed to the third restriction torque Tr3, the target torque is not restricted to the first restriction torque Tr1, and the torque resulting from summation of the assist torque and the vibration torque is set as the target torque without any change. Accordingly, even in a range in which the target torque exceeds the first restriction torque Tr1 (a range of time t31 to time t32 in FIG. 8), the vibration torque is reflected, and the steering wheel 1 can be vibrated.

The value of the third restriction torque Tr3 is set based on the summed value of the assist torque and the vibration torque. Specifically, the target torque setting unit 234 sets the third restriction torque Tr3 to a value slightly larger than the summed value of the assist torque and the vibration torque. Accordingly, because the target torque does not reach the third restriction torque Tr3, the steering wheel 1 can be vibrated by the vibration torque set by the vibration torque setting unit 33.

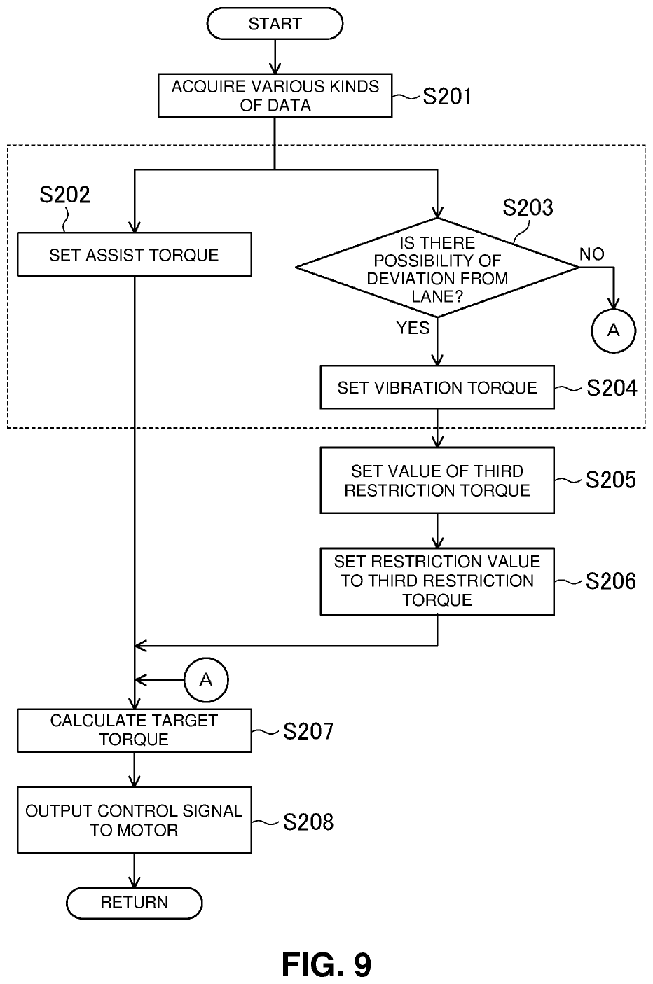

FIG. 9 illustrates a processing action of the ECU 30 according to this second embodiment.

In step S201, the ECU 30 acquires various kinds of data from the sensors 10 to 13.

Next, the ECU 30 in parallel processes step S202, step S203, and step S204.

In the step S202, the ECU 30 sets the assist torque.

Meanwhile, in the step S203, the ECU 30 determines whether or not there is a possibility of deviation from the lane. The ECU 230 moves to step S204 in a case of YES where there is the possibility of deviation from the lane but moves to step S207 in a case of NO where there is no possibility of deviation from the lane.

In the step S204, the ECU 30 sets the vibration torque. The ECU 230 sets the vibration torque such that the torque in the opposite direction to the steering torque is produced.

In the step S205, the ECU 30 sets the value of the third restriction torque Tr3. The ECU 30 sets a value slightly larger than the summed value of the assist torque and the vibration torque as the third restriction torque Tr3.

In next step S206, the ECU 30 sets the restriction value of the target torque to the third restriction torque Tr3.

In the following step S207, the ECU 30 sums the assist torque and the vibration torque and sets the final target torque.

Then, in step S208, the ECU 30 outputs the control signal to the motor 20 such that the target torque calculated in the step S207 is generated.

In this second embodiment, because the target torque is not restricted to the first restriction torque Tr1 either, the steering wheel 1 can appropriately forcibly be vibrated when the forced vibration of the steering wheel 1 is necessary.

### Other Embodiments

The technique disclosed herein is not limited to the above-described embodiments, but substitutions are possible without departing from the scope of the gist of the claims.

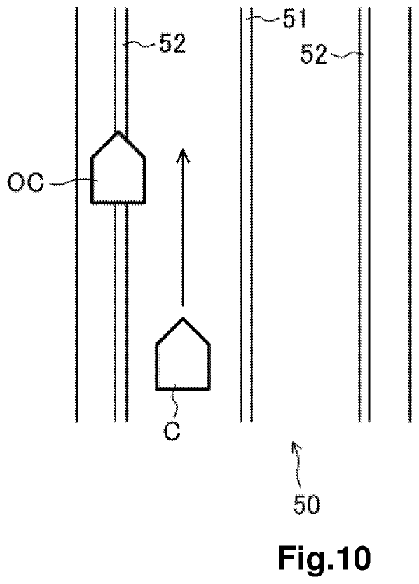

For example, in the above first and second embodiments, the predetermined condition is the condition that the vehicle C might deviate from the traveling lane. Instead of this or in addition to this, a condition that the vehicle C might collide with an obstacle may be set as a predetermined condition. For example, as illustrated in FIG. 10, it is assumed that another vehicle OC has stopped on a road shoulder and the own vehicle C avoids the other vehicle OC as indicated by the black arrow. In this case, when the distance between the own vehicle C and the other vehicle OC is less than a set distance set in advance (for example, 1 m) from the detection results of the cameras 12 and the radars 13, the forced vibration may be produced for the steering wheel 1. Note that in a case of the forced vibration for attracting attention to approach to an obstacle, the vibration torque is set to a torque by which the steering wheel 1 rotates in the opposite direction to a direction in which the obstacle is present. In other words, when the obstacle is present on a left side and the vehicle C turns to the right to avoid a liaison object, the vibration torque in the same direction as the assist torque is generated.

Further, in the above first and second embodiments, the ECU 30 changes the restriction value of the target torque in response to establishment of the predetermined condition. The ECU 30 is not limited to this configuration and may be configured to cancel the restriction value of the target torque in response to establishment of the predetermined condition. Further, for example, in a case where the third restriction torque Tr3 is set as in the second embodiment, the third restriction torque Tr3 is set to infinity, and the restriction value of the target torque may thereby substantially be canceled.

Further, in the above first embodiment, the second restriction torque Tr2 is set to a value smaller than the first restriction torque Tr1. The second restriction torque Tr2 is not limited to this but may be a value larger than the first restriction torque Tr1.

The above-described embodiments are merely examples, and the scope of the present disclosure should not be construed in a limited manner. The scope of the present disclosure is defined by the claims, and all modifications and variations belonging to the equivalent scope of the claims are included in the scope of the present disclosure.

The technique disclosed herein is useful for a power steering apparatus including a motor for giving an assist torque to a steering apparatus including a steering wheel operated by a driver in a case where restriction is placed on a torque generated by a motor.

What is claimed is:

1. A power steering apparatus comprising:
a motor configured to apply an assist torque to a steering apparatus including a steering wheel operated by a driver of a vehicle; and
a controller configured to control actuation of the motor, such that
in response to establishment of a predetermined condition, the controller sets a vibration torque for vibrating the steering wheel, sets a summed value of the assist torque and the vibration torque as a target torque, and controls the motor such that the target torque is generated, and
when the predetermined condition is not satisfied and the target torque is a predetermined first restriction torque or greater, the controller further restricts a maximum value of the target torque to the first restriction torque, and when the predetermined condition is satisfied, the controller further changes the restriction on the maximum value of the target torque.

2. The power steering apparatus according to claim 1, wherein
when the predetermined condition is satisfied, the controller periodically changes a restriction value of the target torque to the first restriction torque and a second restriction torque different from the first restriction torque.

3. The power steering apparatus according to claim 2, wherein
the second restriction torque is smaller than the first restriction torque.

4. The power steering apparatus according to claim 1, wherein
the controller includes a vibration torque setting unit configured to set a motor torque as a pulse wave with a specific period, and is configured to control the motor to generate the motor torque as the vibration torque to vibrate the steering wheel.

5. The power steering apparatus according to claim 1, wherein
the controller comprises a forced vibration determination unit configured to determine whether the vehicle could deviate from the traveling lane, and
the controller is configured to forcibly vibrate the steering wheel by a forced vibration in accordance with the vibration torque when the forced vibration determination unit determines that the vehicle could deviate from the traveling lane.

6. The power steering apparatus according to claim 5, wherein
the forced vibration determination unit is configured to determine whether or not the vehicle could deviate from the traveling lane based on detection results of a camera and a radar, such that a center of a roadway and roadway outer-side lines which divide the roadway from road side strips are acquired by the camera and the radar as road conditions, and the forced vibration determination unit calculates a distance between the vehicle and the center line based on the detection results of the camera and the radar, and
in a case where the distance is less than a predetermined distance, the forced vibration determination unit determines that the vehicle could deviate from the traveling lane, and the controller causes the forced vibration of the steering wheel.

7. The power steering apparatus according to claim 5, wherein
the controller includes a vibration torque setting unit configured to set a motor torque as a pulse wave with a specific period, and is configured to control the motor to generate the motor torque as the vibration torque to vibrate the steering wheel.

8. The power steering apparatus according to claim 6, wherein
the controller includes a vibration torque setting unit configured to set a motor torque as a pulse wave with a specific period, and is configured to control the motor to generate the motor torque as the vibration torque to vibrate the steering wheel.
